(19) United States
(12) Patent Application Publication
(10) Pub. No.: US 2011/0180443 A1
(43) Pub. Date: Jul. 28, 2011

(54) METHOD OF PRODUCING POUCHES AND POUCHES

(75) Inventors: Keizou Kanzaki, Yokohama-shi (JP); Jyun Matsushima, Yokohama-shi (JP); Atsushi Fukahori, Yokohama-shi (JP)

(73) Assignee: TOYO SEIKAN KAISHA, LTD., Chiyoda-ku, Tokyo (JP)

(21) Appl. No.: 13/121,474

(22) PCT Filed: Dec. 16, 2009
(86) PCT No.: PCT/JP2009/070968

§ 371 Date: Mar. 29, 2011

(30) Foreign Application Priority Data
Dec. 19, 2008 (JP) 2008-323922

(51) Int. Cl. B65D 33/00; B31B 1/88

(52) U.S. Cl. 206/459.5; 493/187

(57) ABSTRACT

A method of producing pouches which comprise a laminate of at least an outer surface member and a heat-sealable inner surface member, and having a printed layer formed on the outer surfaces thereof, wherein an anchor coating having anti-blocking property is formed on the surface of said outer surface member, said laminate is formed into pouches, and the outer surfaces of said pouches are irradiated with an electron beam or an ultraviolet ray to thereby form a printed layer. The method makes it possible to efficiently produce unprinted pouches from which pouches of various kinds can be produced in small lots, and to print the unprinted pouches in sheet form maintaining good productivity.

### TECHNICAL FIELD

This invention relates to a method of producing pouches and to pouches. More specifically, the invention relates to a method of producing pouches, which is capable of producing pouches of various kinds in small lots maintaining good productivity and to pouches.

### BACKGROUND ART

A plastic pouch comprising a laminate of at least an outer surface member and a heat-sealable inner surface member and printed on the outer surface thereof, has heretofore been produced by, first, forming a printed layer by gravure-printing a long resin film that constitutes the outer surface member, applying an adhesive thereon, laminating the printed layer on the heat-sealable inner surface member to form a laminate thereof, effecting the curing (curing the adhesive), and forming the laminate into a pouch.

The gravure printing onto a long resin film features a fast printing speed and excellent durability of the printing plate, and is suited for producing products in large lots accompanied, however, by such defects that an extended period of time is required for exchanging the printing plate and that the printing plate is expensive. It is, therefore, difficult to apply the gravure printing to the production of pouches of various kinds in small lots.

In recent years, importance has been given to designs printed on the pouches, and it has been demanded to produce pouches of various kinds in small lots. Therefore, a technology has been proposed according to which after unprinted pouches are produced in large quantity, the outer surfaces of the pouches are printed by an electrophotographic method (patent document 1). However, the electrophotographic method requires a facility of a large scale and is not satisfactory from the standpoint of productivity, either. Therefore, it has been desired to shorten the time for exchanging the printing plate and to conduct the printing relying, for example, on an off-set printing using an inexpensive printing plate.

To print the pouch in a multiplicity of colors, on the other hand, it is desired to effect the continuous multi-color printing in one color each time and to continuously apply a finishing varnish followed readily by curing. Here, the ink and the finishing varnish can be cured by any one of the ultraviolet ray (UV) curing, thermal curing or electron beam (EB) curing. It is, however, desired that the pouch after molded is printed relying on the ultraviolet ray curing and the electron beam curing which are capable of attaining the curing in a short period of time without thermally damaging the pouches.

When the ink and the finishing varnish are applied and cured relying on the ultraviolet ray curing and the electron beam curing, however, adhesiveness decreases among the printed layer, the finishing varnish layer and the surface of the pouch as the ink and the finishing varnish undergo shrinking due to their crosslinking. Therefore, the printed layer and the finishing varnish layer tend to be peeled off when the pouches are being transported, when the contents are being filled or when the retort sterilization is being effected, arousing a problem of blistering at the time of retort sterilization.

To solve the above problem, a method has been proposed according to which an anchor coating is formed on the surface of the film and, thereafter, a printed layer and a finishing varnish layer are formed (patent document 2).

### PRIOR ART TECHNOLOGY

### Patent Document

Patent document 1: JP-A-8-194325
Patent document 2; JP-A-2005-225083

### OUTLINE OF THE INVENTION

### Problems that the Invention is to Solve

It was, however, learned that if the unprinted pouches forming the anchor coating, or the outer surface members or the laminates forming the anchor coating are stored in a manner of being stacked one upon the other or being wound, then the anchor coatings come in contact with each other giving rise to the occurrence of blocking, making it difficult to separate the pouches piece by piece or to unwind the outer layer member or the laminate.

It is, therefore, an object of the present invention to provide a method of producing pouches, which is capable of efficiently producing unprinted pouches that can be turned into pouches of various kinds in small lots, and is capable of printing the unprinted pouches in sheet form maintaining good productivity.

Another object of the invention is to provide a method of producing pouches, which is capable of producing pouches and printing pouches maintaining good productivity while effectively preventing the blocking among the unprinted pouches or among the outer surface layers or the laminates on which the anchor coating is formed.

A further object of the invention is to provide unprinted pouches on which an anchor coating is formed and printed pouches comprising the unprinted pouches.

### Means for Solving the Problems

According to the present invention, there is provided a method of producing pouches which comprise a laminate of at least an outer surface member and a heat-sealable inner surface member, and having a printed layer formed on the outer surfaces thereof, wherein an anchor coating having anti-blocking property is formed on the surface of the outer surface member, the laminate is formed into pouches, and the outer surfaces of the pouches are irradiated with an electron beam or an ultraviolet ray to thereby form a printed layer.

According to the method of producing pouches of the invention, it is desired that:

1. The anchor coating contains an anti-blocking agent;
2. The anti-blocking agent comprises fine particles of at least any one of silica, titanium oxide or barium sulfate having an average particle size of 0.1 to 10 μm, and is blended in an amount of 0.1 to 10 parts by weight in the case of silica or in an amount of 0.1 to 150 parts by weight in the case of titanium oxide or barium sulfate per 100 parts by weight of the resin component of an anchor coating agent that forms the anchor coating;
3. A finishing varnish layer is formed on the printed layer by the irradiation with the electron beam or the ultraviolet ray;
4. The unprinted pouches of prior to forming the printed layer are stored for extended periods of time in a stacked manner, or the laminate on which the anchor coating is formed is wound and is stored for extended periods of time;
5. The anchor coating comprises an anchor coating agent of a polyurethane resin or a polyester resin; and
6. The pouches after having been filled with a content are subjected to the sterilization by heating.

According to the present invention, further, there are provided pouches which comprise a laminate of at least an outer surface member and a heat-sealable inner surface member, and including an anchor coating having anti-blocking property formed on the surface of the outer surface member.

In the pouches of the present invention, it is desired that the anchor coating contains an anti-blocking agent.

The invention, further, provides printed pouches having a printed layer formed on the anchor coating of the pouches.

In the printed pouches of the present invention, it is desired that a finishing varnish layer is formed on the printed layer.

### Effects of the Invention

According to the method of producing pouches of the invention, the unprinted pouches do not become blocked even when the unprinted pouches are stacked and stored for extended periods of time, and can be printed in sheet form maintaining good productivity.

According to the method of producing pouches of the invention, further, the time for exchanging the printing plate can be shortened, the inexpensive printing plate can be used and, therefore, pouches of various kinds can be produced in small lots maintaining good productivity.

The invention, further, provides printed pouches featuring excellent adhesiveness of the printed layer and excellent appearance even when subjected to the sterilization by heating, such as retort sterilization.

### BEST MODE FOR CARRYING OUT THE INVENTION

Briefly speaking, the method of producing pouches of the invention comprises a step of forming an anchor coat-formed laminate that includes at least an outer surface member and a heat-sealable inner surface member, and has an anchor coating formed on the surface of the outer surface member; a step of forming unprinted pouches from the anchor coat-formed laminate; and a step of forming a printed layer on the outer surfaces of the unprinted pouches by the irradiation with an electron beam or an ultraviolet ray and, as required, forming a finishing varnish layer thereon. These steps do not necessarily have to be continuously carried out. Among or during these steps, the unprinted pouches can be stored for extended periods of time in the form of intermediate products for forming printed pouches. Even when stored for extended periods of time in any of these steps, the intermediate products do not become blocked to each other and from which the printed pouches can be produced maintaining good productivity.

According to the production method of the present invention, first, a laminate comprising at least an outer surface member and a heat-sealable inner surface member is formed, the laminate having an anchor coating that has been formed in advance on the surface of the outer surface member.

The laminate forming the anchor coating can be produced by either forming an anchor coating on the surface of the outer surface member of the laminate that comprises the outer surface member and the heat-sealable inner surface member, or forming the anchor coating on the outer surface member, first, and, thereafter, laminating the heat-sealable inner surface member on the outer surface member on the side opposite to the surface on where the anchor coating has been formed.

According to the present invention, the anchor coating which becomes the cause of blocking has anti-blocking property. Therefore, no blocking takes place even when the anchor coat-formed laminate and the anchor coat-formed outer surface member are wound in an elongated form and are stored for extended periods of time before being formed into unprinted pouches. Therefore, the anchor coat-formed laminate and the anchor coat-formed outer surface member can be smoothly fed to a next step.

Next, the laminates on which the anchor coating is formed are overlapped one upon the other in a manner that the heat-sealable inner surface members are on the inside, and are heat-sealed to form a pouch which has not been printed yet.

According to the present invention as described above, the anchor coating has been prevented from becoming blocked. Prior to conducting the next step of printing, therefore, the laminates can be stored for extended periods of time in the form of unprinted pouches.

According to the present invention, an ultraviolet ray-curable or electron beam-curable ink and, as required, a finishing varnish are applied onto the outer surfaces of the thus formed unprinted pouches, and are irradiated with the ultraviolet ray or the electron beam to form printed pouches having a printed layer and having, as required, a finishing varnish layer formed on the outer surfaces thereof. The ultraviolet ray or the electron beam works to attain the curing in short periods of time without thermally damaging the pouches and, therefore, an excellent productivity can be realized.

During the curing, on the other hand, the ink and the varnish shrink while the outer surface member does not shrink, and it becomes probable that the printed layer and the finishing varnish layer that is formed as required may peel off the outer surface member. According to the present invention, however, the anchor coating formed on the surface of the outer surface member works to relax stress generated in the ink and in the varnish by the curing. Therefore, the printed layer and the finishing varnish layer are effectively prevented from being peeled off.

### (Laminate)

As the laminate comprising at least the outer surface member and the heat-sealable inner surface member, there can be used any laminate that has heretofore been used for forming pouches.

As the outer surface member, there can be exemplified polyolefin resin, polyester resin, polyamide resin, polycarbonate resin and cellophane.

As the polyolefin resin, there can be exemplified low-, medium- or high-density polyethylene (LDPE, MDPE, HDPE), polypropylene (PP), linear low-density polyethylene (LLDPE), ethylene/propylene copolymer, polybutene-1, ethylene/butene-1 copolymer, propylene/butene-1 copolymer, ethylene/propylene/butene-1 copolymer, ethylene/vinyl acetate copolymer, ionically crosslinked olefin copolymer (ionomer), ethylene/acrylic acid ester copolymer, and a blend thereof.

As the polyester resin, there can be exemplified such polyesters as polyethylene terephthalate (PET), polybutylene terephthalate, polyethylene naphthalate, ethylene terephthalate/isophthalate copolymer, and a blend thereof.

As the polyamide resin, there can be exemplified such polyamides as nylon 6, nylon 6,6, nylon 11, nylon 12, a copolymerized polyamide such as nylon 6/6,6, and a blend of two or more kinds thereof.

As the polycarbonate resin (PC), there can be exemplified polycarbonate and polycarbonate Z from bisphenols such as bisphenol A or F.

As the heat-sealable inner surface member, there can be preferably used the above-mentioned polyolefin resin and, particularly preferably, the one that has not been stretched.

Further, the laminate used in the invention is not limited to the one of the two-layer structure comprising the outer surface member and the heat-sealable inner surface member, but may be the one of a multi-layer structure having three or four or more layers. In order to impart gas-barrier property such as oxygen-barrier property to the pouches, for example, there may be formed, as intermediate layers, any one or more of a gas-barrier resin layer such as of ethylene/vinyl alcohol copolymer, a metal foil such as aluminum foil or steel foil, or a vapor deposited film obtained by depositing an inorganic matter or a metal on a resin film, a layer comprising the above polyamide resin for improving shock resistance, and a layer comprising an oxygen-absorbing resin composition or a regrind (scrap resin). As required, further, an adhesive resin layer may be provided among the neighboring resin layers, as a matter of course.

As required, further, the outer surface member may be blended with a white pigment such as titanium oxide. Or, the outer surface member may be solidly printed on the surface thereof on the side opposite to the anchor coating.

In the invention, though there is no limitation, there can be preferably used a laminate comprising polyester/nylon/gas-barrier layer/polyolefin in this order from the outer surface side.

### (Anchor Coating)

As the anchor coating used in the invention, there can be used any known anchor coating agent such as polyurethane anchor coating agent, polyester anchor coating agent, alkyl titanate anchor coating agent, polybutadiene anchor coating agent or polyethyleneimine anchor coating agent. From the standpoint of effectively relaxing the stress that generates when the ink and the finishing varnish contract, however, it is particularly desired to use the polyurethane or polyester anchor coating agent.

The polyurethane anchor coating agent is prepared, usually, from an isocyanate compound and an activated hydrogen compound. In the invention, in particular, there can be preferably used a polyurethane anchor coating agent containing, as the activated hydrogen compound, a polyester polyol, polyacryl polyol or polycarbonate diol. For the pouches that are to be put to the sterilization by heating such as retort sterilization, it is desired that the polyurethane anchor coating agent comprises a polyester polyol-containing polyurethane resin and, particularly, a hexamethylene diisocyanate (HDI) and a polyester polyol.

When the polyester polyol-containing polyurethane anchor coating agent is used in the invention, it is desired that the anchor coating agent contains an anti-blocking agent to prevent the anchor coating from becoming blocked.

As the anti-blocking agent, there can be used at least any one of the known inorganic anti-blocking agents of the type of silica, calcium carbonate, alumina, silica-alumina, titanium, clay or zeolite, and organic anti-blocking agents comprising crosslinked resin particles such as crosslinked polystyrene particles or crosslinked polyacrylate particles. Among them, silica, titanium oxide and barium sulfate can be particularly preferably used.

A preferred content of the anti-blocking agent differs depending upon its kind that is used and its range cannot be definitely defined. However, when silica is used, the preferred amount “phr (per hundred resin)” is 0.1 to 10 parts by weight and, particularly, 2 to 5 parts by weight and when titanium oxide or barium sulfate is used, the preferred amount is 0.1 to 150 parts by weight and, particularly, 50 to 100 parts by weight per 100 parts by weight of the resin of the anchor coating agent from the standpoint of preventing the anchor coating from becoming blocked. If the content is smaller than the above range, the pouches may develop blocking before being printed. If the content exceeds the above range, on the other hand, adhesion to the ink may become defective.

It is, further, important that the anti-blocking agent has an average particle size in a range of 0.1 to 10 μm and, particularly, 0.5 to 8 μm from the standpoint of preventing the printing performance from being deteriorated while effectively preventing the anchor coating from being blocked. If the average particle size is smaller than the above range, the pouches may develop blocking before being printed. If the average particle size exceeds the above range, on the other hand, the thickness of the ink on the upper part of the anti-blocking agent becomes smaller than that of other portions giving rise to the occurrence of color tone shading.

To find the average particle size of the anti-blocking agent, the anchor coating is observed by using an optical microscope, particles are randomly selected in a number n of 200, and their sizes are found and averaged.

It is desired that the anchor coating agent is applied in an amount in a range of 0.5 to 8 g/m² and, particularly, 1 to 4 g/m². If the amount of application is smaller than the above range, adhesion to the ink tends to become defective. If the amount of application exceeds the above range, on the other hand, the pouches tend to be blocked by each other.

As described above, the anchor coating can be formed by applying the anchor coating agent onto the long laminate or the film after the laminate has been produced or while the laminate is being produced. Though not limited thereto only, however the anchor coating agent can be applied by gravure coating or roll coating, and can be heat-treated at a temperature of 70 to 150° C. for 0.5 to 10 seconds so as to be dried. Thereafter, the film is wound and is aged at 30 to 80° C. for 1 to 7 days to form the anchor coating.

### (Ink and Finishing Varnish)

In the invention, it is desired to use the ultraviolet ray-curable or electron beam-curable ink and finishing varnish from the standpoint of printing the pouches maintaining good productivity without damaging them.

In the invention, the printed layer and the finishing varnish layer can be formed by using a known ultraviolet ray-curable or electron beam-curable ink and finishing varnish. To produce the pouches for foods, it is desired to use an electron beam-curable ink and finishing varnish. That is, the electron beam-curable ink and finishing varnish are cured by using an electron beam having high energy permeability. Unlike the ultraviolet ray-curable ink, therefore, there is no need of adding a photo-sensitizing agent or a reaction initiator, offering advantage from the hygienic point of view.

The ultraviolet ray-curable ink and finishing varnish require a photo-sensitizing agent and a reaction initiator, and are, desirably, used for producing pouches for containing detergents and the like other than foods from the hygienic point of view.

Here, the finishing varnish is applied in an amount of 1 to 8 g/m² and, desirably, 2 to 6 g/m². If the amount of application exceeds the upper limit, blistering may occur after the retort sterilization due to insufficient degree of curing of the resin. If the amount of application is smaller than the lower limit, luster and smoothness may often become insufficient.

As the ultraviolet ray-curable ink, there can be used any one comprising a known ultraviolet ray-curable resin composition and a pigment. Preferably, there can be used an ultraviolet ray-curable resin composition comprising epoxy acrylate, polyester acrylate, polyurethane acrylate, epoxy methacrylate, polyester methacrylate, polyurethane methacrylate, polyene-polythiol compound, unsaturated polyester, liquid polybutadiene compound or aminoalkyd resin, and polymerization initiator or reaction initiator in combination.

Further, the ultraviolet ray-curable finishing varnish may be the same one as the one used for the printing ink except that it is blended with no pigment and it has excellent transparency.

As the electron beam-curable ink, there can be used any one comprising a known electron beam-curable resin composition and a pigment. As the electron beam-curable resin composition, there can be used epoxy acrylate, polyester acrylate, polyurethane acrylate, epoxy methacrylate, polyester methacrylate, polyurethane methacrylate, polyene-polythiol compound, unsaturated polyester, liquid polybutadiene compound or aminoalkyd resin. The finishing varnish may be the same one as the one used for the printing ink except that it is blended with no pigment and it has excellent transparency.

According to the present invention, the anchor coating of the unprinted pouches is printed in sheet form for each of the pouches. That is, a multi-color printing is conducted by using the above ultraviolet ray-curable or electron beam-curable ink, and the finishing varnish is applied thereon followed by curing to thereby form a printed layer and a finishing varnish layer on each piece of pouch.

The printing system will be gravure printing system, flexo printing system, offset printing system, ink jet printing system or screen printing system. From the standpoint of easily exchanging the printing plate and using an inexpensive printing plate, however, it is desired to employ the offset printing system featuring a high printing speed.

The curing by using an ultraviolet ray can be conducted according to a known method by using, usually, a light ray of a wavelength of 200 to 440 nm. As the source of ultraviolet ray, there can be used a low-pressure or high-pressure mercury lamp, metal halide lamp, xenon lamp, electrodeless discharge lamp or carbon arc lamp.

The curing by the electron beam can be conducted according to a known method, and the electron beam irradiation apparatus may be any one of the curtain beam type, area beam type, broad beam type, scanning beam type or vacuum tube type. The electron beam is, desirably, a low-energy beam having an acceleration voltage of 30 to 150 KV and, preferably, 70 to 130 KV. If the acceleration voltage is lower than this range, the ink and the finishing varnish are not fully cured. If the acceleration voltage exceeds this range, the electron beam reaches the heat-sealing layer of the pouch causing the heat-sealing layer to be deteriorated and, therefore, lowering the sealing strength and the resistance when fallen down.

### (Forming the Pouches)

According to the present invention, the long laminates forming the anchor coating are overlapped one upon the other in a manner that the heat-sealable inner surface members are on the inside, and the required portions are heat-sealed. Thereafter, the laminates are cut. Here, the laminates can be stored for extended periods of time in a state where a plurality of unprinted pouches are continuing prior to being cut, or can be fed to the step of printing.

The unprinted pouches have excellent anti-blocking property despite the anchor coating has been formed thereon. Therefore, even after stored in a stacked manner, the unprinted pouches can be fed to the step of printing piece by piece, and the printed pouches can be efficiently produced.

### EXAMPLES

### Example 1

### Preparation of a Multi-Layer Film for Pouches

The anchor coating was applied by gravure coating onto one side of a long biaxially stretched polyethylene terephthalate film having a thickness of 12 μm in an amount of 2.5 g/m² and was dried. Thereafter, the long film was wound and stored at 55° C. for 5 days so that the anchor coating was aged.

Next, an urethane resin two-package curing type adhesive was applied onto the surface of the film on where the anchor coating has not been formed in an amount of 4 g/m² and was dried and, thereafter, an aluminum foil of a thickness of 7 μm was laminated thereon. Next, the urethane resin two-package curing type adhesive was applied onto the surface of the aluminum foil in an amount of 4 g/m² and was dried, and an unstretched polypropylene resin was laminated thereon as a heat-sealing layer maintaining a thickness of 70 μm. The film was wound and was aged at 55° C. for 3 days to cure the adhesive to thereby obtain a long multi-layer film for pouches. The anchor coating was formed by using the two-package curing type resin comprising a polyurethane resin (containing polyester polyol) and an HDI (hexamethylene diisocyanate) curing agent, which was, further, blended with silica as an anti-blocking agent. The silica possessed an average particle size of 2 and was blended in an amount of 2.5 phr.

### (Preparation of Pouches)

The heat-sealing layers of the obtained long multi-layer films for pouches were overlapped one upon the other, and the portions that should form the frame of a pouch were heat-sealed together over a sealing width of 10 mm at 210° C. for one second, followed by cutting into a pouch size (130 mm×170 mm) to obtain individual pouches which were then stored in a stacked manner.

### (Preparation of Printed Pouches)

The pouches were taken out from the stored stack, an electron beam-curable ink (indigo-blue) was solidly printed on the surfaces on one side of the pouches in an amount of 1.5 g/m² by using an R1 tester, an electron beam-curable finishing varnish was applied thereon in a wet form in an amount of 4 g/m², and the ink and the finishing varnish were cured by the irradiation with an electron beam in a dose of 50 kGy to prepare printed pouches. The finishing varnish was applied onto the whole printed surface.

### <Evaluation of Pouches>

(Evaluation of Ink Adhesion after Retort)

200 Grams of water was introduced into the obtained pouch which was then heat-sealed to prepare a sample. After treated in a steam retort at 130° C. for 30 minutes, the sample was cooled and dried. By using a cutter, a character X was engraved in the printed surface of the pouch through the finishing varnish, and an adhesive surface of a cellophane tape (manufactured by Nichiban Co.) was stuck thereto. The tape that was stuck was strongly pressed by the ball of the thumb. Thereafter, an end of the tape was held by one hand and was stripped off while holding the sample by the other hand so that it was not lifted up.

The evaluation was on the following basis. Symbols ◯ and Δ represent that the pouches were allowable as products.
◯: There was no stripping at all.
Δ: Stripped area was less than 30% of the whole area.
X: Stripped area was not less than 30% of the whole area.
   (Evaluation of Appearance after Retort)

The pouches subjected to the retort treatment in the same manner as described above were visually evaluated for their appearance. The evaluation was on the following basis.
◯: No wrinkle was formed by the peeling of ink.
X: Wrinkles were formed by the peeling of ink.

### (Evaluation of Anti-Blocking of Pouches Before Printed)

20 Pieces of the pouches before printed were stacked and were put into a constant temperature oven maintained at 35° C. in which a load of 8 Kg (weight having a bottom area of 10 cm×10 cm) was exerted thereon. After 24 hours have passed, the stack was taken out, and was left to cool down to room temperature while maintaining the load exerted thereon. Thereafter, the closely contacting surfaces while the load was being exerted thereon were carefully and slowly stripped off to observe the state of blocking. The evaluation was on the following bases. Symbols ◯ and Δ represent that the pouches were allowable as products.
◯: Pouches were not adhered to each other.
Δ: Pouches were partly and slightly adhered to each other but there was no problem from the standpoint of production.
X: Pouches were adhered to each other and could not be stripped off.

### Examples 2 to 5

Printed pouches were produced in the same manner as in Example 1 but blending the anchor coating with the anti-blocking agent in amounts as shown in Table 1, and were evaluated.

### Example 6

Printed pouches were produced in the same manner as in Example 1 but using an ultraviolet ray-curable ink as the printing ink and an ultraviolet ray-curable finishing varnish as the finishing varnish, and irradiating ultraviolet rays by using a mercury lamp so as to obtain irradiation energy of 140 mJ/cm² (as measured by using the “FUSION UVIMAP” manufactured by FUSION UV Systems Japan Co.), and were evaluated.

### Comparative Example 1

Pouches were produced in the same manner as in Example 1 and were stored in a stacked manner. Pouches were taken out from the stored stack and on which a thermosetting ink was applied in an amount of 2.5 g/m², a thermosetting finishing varnish was applied in an amount of 5 g/m², followed by curing under the conditions of 180° C. for 2 minutes to produce printed pouches. It was attempted to evaluate the obtained pouches in the same manner as in Example 1. However, the inner surface layers were melt-adhered together due to the heat at the time of curing, and water packs could not be formed. Accordingly, the pouches were not evaluated.

Here, the anti-blocking property was rated to be “0”.

### Comparative Example 2

Printed pouches were produced in the same manner as in Example 1 but without forming anchor coating on the surface of the biaxially stretched polyethylene terephthalate film, and were evaluated.

### Comparative Example 3

Printed pouches were produced in the same manner as in Example 1 but without blending the anchor coating with the anti-blocking agent, and were evaluated.

In this Comparative Example, the anti-blocking property of the pouches was rated to be “X”. Therefore, neither the close adhesion of ink after the retort sterilization nor the appearance after the retort sterilization was evaluated.

The results of evaluation of Examples 1 to 6 and Comparative Examples 1 to 3 were as shown in Table 1.

TABLE 1

| | Pouch | | | | | | |
|---|---|---|---|---|---|---|---|
| | | Anchor coating | | | Evaluation | | |
| | | | Amount of | Silica | Adhesion of | Appearance | |
| | Printing | | silica | size | ink after | after | Anti- |
| | method | Resin | (phr) | (μm) | retort | retort | blocking |
| Ex. 1 | EB | A | 2.5 | 2 | ◯ | ◯ | ◯ |
| Ex. 2 | EB | A | 10 | 2 | Δ | ◯ | ◯ |
| Ex. 3 | EB | A | 0.1 | 2 | ◯ | ◯ | Δ |
| Ex. 4 | EB | A | 2.5 | 10 | ◯ | ◯ | ◯ |
| Ex. 5 | EB | A | 2.5 | 0.1 | ◯ | ◯ | Δ |
| Ex. 6 | UV | A | 2.5 | 2 | ◯ | ◯ | ◯ |
| Comp. | Thermosetting | A | 2.5 | 2 | * | * | ◯ |
| Ex. 1 | | | | | | | |
| Comp. | EB | none | none | none | X | X | ◯ |
| Ex. 2 | | | | | | | |
| Comp. | EB | A | none | none | ** | ** | X |
| Ex. 3 | | | | | | | |

EB: electron beam-cure printing
UV: ultraviolet ray-cure printing
Thermosetting: thermosetting printing
*: not evaluated since inner surface layers melt-adhered
**: not evaluated since pouches were blocked

### Example 7

Printed pouches were produced in the same manner as in Example 1 but using a polyester resin of the crosslinking type having anti-blocking property as the anchor coating resin, without adding the anti-blocking agent, and without conducting the retort sterilization, and were evaluated for their adhesion of ink. As a result, the anti-blocking property and the adhesion of ink were evaluated to be favorable.

### Example 8

Printed pouches were produced and evaluated in the same manner as in Example 7 but using, as the anchor coating resin, a two-package curing resin obtained by adding an HDI (hexamethylene diisocyanate) curing agent to a polyurethane resin containing a polyacrylpolyol having anti-blocking property. As a result, the anti-blocking property and the adhesion of ink were evaluated to be favorable.

### INDUSTRIAL APPLICABILITY

According to the method of producing pouches of the invention, the unprinted pouches do not become blocked even when they are stored for extended periods of time in a stacked manner. Therefore, the invention can be effectively utilized for producing unprinted pouches which can be desirably used for producing printed pouches of various kinds in small lots.

By using the unprinted pouches, further, the printed pouches of various kinds can be produced in small lots maintaining good productivity owing to a shortened time for exchanging the printing plate and use of an inexpensive printing plate.

Further, even when placed under high temperature and highly humid conditions, the printed pouches of the invention excel in adhesion of the printed layer and appearance. Therefore, the printed pouches of the invention can be favorably put to the sterilization by heating such as retort sterilization.

1. A method of producing pouches which comprise a laminate of at least an outer surface member and a heat-sealable inner surface member, and having a printed layer formed on the outer surfaces thereof, wherein an anchor coating having anti-blocking property is formed on the surface of said outer surface member, said laminate is formed into pouches, and the outer surfaces of said pouches are irradiated with an electron beam or an ultraviolet ray to thereby form a printed layer.

2. The production method according to claim 1, wherein said anchor coating contains an anti-blocking agent.

3. The production method according to claim 2, wherein said anti-blocking agent comprises fine particles of at least any one of silica, titanium oxide or barium sulfate having an average particle size of 0.1 to 10 μm, and is blended in an amount of 0.1 to 10 parts by weight in the case of silica or in an amount of 0.1 to 150 parts by weight in the case of titanium oxide or barium sulfate per 100 parts by weight of the resin component of an anchor coating agent that forms the anchor coating.

4. The production method according to claim 1, wherein a finishing varnish layer is formed on said printed layer by the irradiation with the electron beam or the ultraviolet ray.

5. The production method according to claim 1, wherein the unprinted pouches of prior to forming said printed layer are stored for extended periods of time in a stacked manner, or the laminate on which the anchor coating is formed is wound and is stored for extended periods of time.

6. The production method according to claim 1, wherein said anchor coating comprises an anchor coating agent of a polyurethane resin or a polyester resin.

7. The production method according to claim 1, wherein said pouches after having been filled with a content are subjected to the sterilization by heating.

8. Pouches which comprise a laminate of at least an outer surface member and a heat-sealable inner surface member, and including an anchor coating having anti-blocking property formed on the surface of the outer surface member.

9. The pouches according to claim 8, wherein said anchor coating contains an anti-blocking agent.

10. Printed pouches having a printed layer formed on the anchor coating of the pouches of claim 8.

11. The printed pouches according to claim 10, wherein a finishing varnish layer is formed on said printed layer.
